(19) United States
(12) Patent Application Publication
(10) Pub. No.: US 2025/0184974 A1
(43) Pub. Date: Jun. 5, 2025

(54) SLOT FORMAT ENHANCEMENTS FOR RF ENERGY HARVESTING FOR AMBIENT IOT

(71) Applicant: APPLE INC., Cupertino, CA (US)

(72) Inventors: Ankit Bhamri, Bad Nauheim (DE); Wei Zeng, Saratoga, CA (US); Sigen Ye, San Diego, CA (US); Haitong Sun, Cupertino, CA (US); Dawei Zhang, Saratoga, CA (US); Weidong Yang, San Digeo, CA (US); Huaning Niu, San Jose, CA (US); Rolando E. Bettancourt Ortega, Munich (DE)

(21) Appl. No.: 18/925,622

(22) Filed: Oct. 24, 2024

Related U.S. Application Data
(60) Provisional application No. 63/604,820, filed on Nov. 30, 2023.

(51) Int. Cl. H04W 72/0446; H02J 50/00; H04W 72/541

(52) U.S. Cl. CPC H04W 72/0446; H02J 50/001; H04W 72/541

(57) ABSTRACT

Described herein are systems, apparatuses and methods with slot format enhancements for radio frequency (RF) harvesting. RF harvesting enhancements may facilitate the use of ambient IoT devise. In some embodiments, a network node may allocate symbols within a slot and configure one or more of the symbols within the slot as one or more RF harvesting symbols. The network node may transmit data during downlink symbols of the slot, and receive data from one or more user equipment (UE) devices during uplink symbols of the slot. Further, the network node may reserve the one or more RF harvesting symbols for transmission of an RF harvesting signal.

### TECHNICAL FIELD

This application relates generally to wireless communication systems, including incorporating RF energy harvesting signals in a slot.

### BACKGROUND

Wireless mobile communication technology uses various standards and protocols to transmit data between a base station and a wireless communication device. Wireless communication system standards and protocols can include, for example, 3rd Generation Partnership Project (3GPP) Long Term Evolution (LTE) (e.g., 4G), 3GPP New Radio (NR) (e.g., 5G), and Institute of Electrical and Electronics Engineers (IEEE) 802.11 standard for Wireless Local Area Networks (WLAN) (commonly known to industry groups as Wi-Fi®).

As contemplated by the 3GPP, different wireless communication systems' standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, Global System for Mobile communications (GSM), Enhanced Data Rates for GSM Evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements Universal Mobile Telecommunication System (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC) while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example of an enhanced slot format in accordance with embodiments disclosed herein.

FIG. 2 illustrates an example of the reconfiguration of a flexible symbol, according to embodiments disclosed herein.

FIG. 3 illustrates examples of different configurations and combinations of an RF symbol in the slot format, according to embodiments disclosed herein.

FIG. 4 illustrates an example of the configuration of a downlink symbol as an RF symbol, according to embodiments disclosed herein.

FIG. 5 illustrates an example of the configuration of an uplink symbol as an RF symbol, according to embodiments disclosed herein.

FIG. 6 illustrates a method in accordance with one embodiment of the present disclosure.

FIG. 7 illustrates a method in accordance with one embodiment of the present disclosure.

FIG. 8 illustrates an example architecture of a wireless communication system, according to embodiments disclosed herein.

FIG. 9 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

Additionally, embodiments herein are described with regard to Internet of Things (IoT) devices. Reference to an IoT device is merely provided for illustrative purposes, and the embodiment herein may be utilized with any device that have the capability to collect and exchange data. IoT devices may be embedded with sensors, software, and network connectivity, allowing them to communicate with other devices and systems. IoT devices can vary in size, complexity, and functionality. They can range from small, simple devices such as temperature sensors and smart home appliances to more complex devices like industrial machinery and autonomous vehicles.

Some IoT devices include ambient IoT devices. An ambient IoT device is a device that is able to harvest energy from ambient sources. For example, some ambient IoT devices may use radio frequency (RF) waves for power. To power such devices using RF, embodiments herein provide enhancements to a wireless communication system framework to introduce a new category of device(s) that is able to harvest energy from ambient sources. An ambient IoT device may be referred to as an RF powered device. An ambient IoT device may also be a UE device.

There may be multiple types of ambient IoT devices that the wireless communication system may support. For instance, in terms of energy storage, some devices may be battery-less devices with no energy storage capability at all, and completely dependent on the availability of an external source of energy. Some devices may include limited energy storage capability that do not need to be replaced or recharged manually, but can be charged by harvesting energy from ambient sources. In some embodiments, device categorization may be based on characteristics corresponding to a device (e.g. energy source, energy storage capability, passive/active transmission, etc.).

Embodiments herein consider the following set of ambient IoT devices. IoT device type A includes no energy storage, harvests energy from ambient sources, and has no independent signal generation, but only backscattering transmission. IoT device type B has energy storage from harvesting ambient sources, but does not perform independent signal generation (e.g., backscattering transmission). IoT device type B's use of stored energy can include amplification for backscattered signals. IoT device type C has energy storage from harvesting ambient sources, and has independent signal generation (e.g., active RF component for transmission). One common aspect for all these device categories is that they may solely rely on energy harvested from ambient sources. From a wireless communication system perspective, RF energy harvesting may be considered. For example, the devices may utilize the energy of the incoming signals from other nodes in the system.

Two modes of operation may be considered for devices capable of energy harvesting: mono-static mode, and bi-static mode. In mono-static mode of operation, the reader and emitter are the same. An emitter is the node that provides the RF signal for energy harvesting at ambient IoT device. A reader is the node that receives the signal (backscatters or transmitted) from the ambient IoT device.

In bi-static mode of operation, the reader and emitter are different. Once the ambient IoT device harvests the energy from the RF signal sent by the emitters, the ambient IoT device will respond back to reader. There can be one or multiple emitters. In some embodiments, for a give ambient IoT device, the nodes that might act purely as emitters could possibly be readers for other ambient IoT device. Accordingly, an emitter label does not necessarily mean there are dedicated system nodes for only the purpose of energy harvesting.

Some embodiments herein consider integration/introduction of dedicated signals for the purpose of energy harvesting in a wireless communication framework. This may include enhancements to frame/slot structure for co-existence of ambient IoT device with legacy devices. Furthermore, some embodiments describe how to enable energy harvesting for ambient IoT device considering both network nodes (e.g., gNB/Transmission Reception Points (TRPs)/repeaters) and UE devices as emitters. In other words, embodiments describe how to support either network nodes such as gNB/TRPs/repeaters and/or UE device for the purpose of sending RF energy harvesting signals to ambient IoT device. Some embodiments herein provide solutions considering the support for both mono-static and bi-static modes.

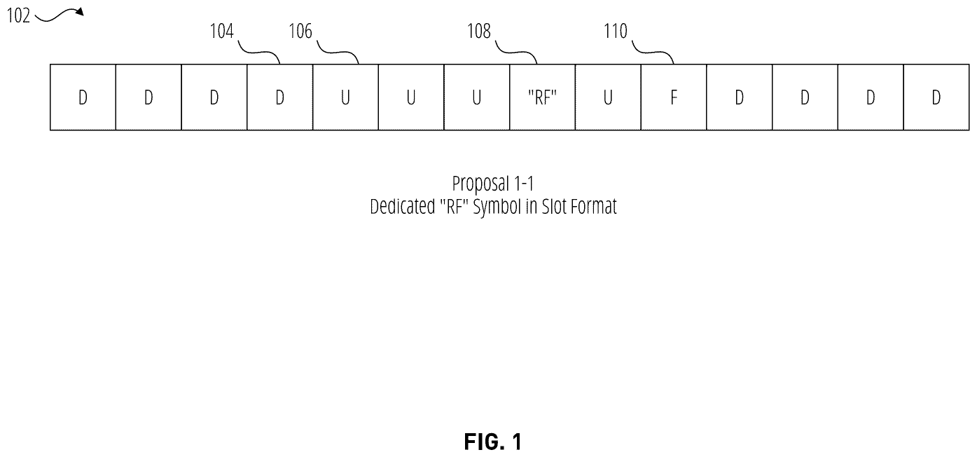

FIG. 1 illustrates an example of a slot format 102 for wireless communication between network nodes (base stations), UEs (user equipment), and ambient IoT devices in accordance with one or more examples of the current disclosure. In at least one embodiment, a slot can refer to a time interval within a frame structure during which data transmission or reception occurs. In some embodiments, symbols can make up a slot, where symbols can refer to units of time where data or information that can be transmitted or received within a slot's time interval. In some embodiments, a network node can be configured to allocate symbols within a slot. Examples of different kinds of symbols may include, but are not limited to downlink symbols, uplink symbols, and flexible symbols. Various actions can be performed during each of the symbols contained within a slot. For example, network nodes can be configured to transmit data during downlink symbols of the slot. Additionally, network nodes can also be configured to receive data from one or more user equipment (UE) devices during uplink symbols.

In some embodiments, a UE can be configured to receive an allocation of symbols within a slot. As discussed with reference to network nodes, different actions can be performed during each symbol. According to the present disclosure, UEs can be configured to receive data from a network node during downlink symbols of the slot. Additionally, UEs can be configured to transmit data to the network node during uplink symbols of the slot.

In some embodiments, the slot format 102 shown in FIG. 1 can be enhanced to introduce a new symbol type. In at least one embodiment, an RF symbol 108 can be included in the slot format 102, where the RF symbol 108 can be a new symbol type that can be configured specifically for transmission and/or reception of an RF harvesting signal. This can be advantageous in that various network nodes (e.g., gNB/TRPs/repeaters) and/or UE devices can be enabled to send RF energy harvesting signals to ambient IoT devices. In turn, this can enable ambient IoT devices to harvest energy from ambient sources in order to transmit and/or receive transmissions when not connected to a dedicated power source. In some embodiments, the slot format 102 can reserve the one or more RF symbols 108 within the slot pattern for transmission of an RF harvesting signal.

In some embodiments of the current disclosure, the symbols configured as RF symbols 108 within the slot format 102 can allow unmodulated signal transmission. According to the present disclosure, unmodulated signals can be signals transmitted without variation or modulation. In some embodiments, the symbols configured as RF symbols 108 can be configured to allow modulated signal transmission. In at least one embodiment, modulated signals can be signals that have varying characteristics (such as amplitude and frequency) in accordance with the information being transmitted. In this manner, an RF symbol 108 can be used for unmodulated signal transmission or modulated signal transmission. This can further enable an RF harvesting signal to be transmitted and/or received over a wide range of communication methods.

Additionally, the slot format 102 can include other types of symbols for various purposes. In at least one example, the slot format 102 can include a downlink symbol 104. The downlink symbol can be used for downlink transmissions. Similarly, the slot format 102 can also be configured to include an uplink symbol 106. In at least one embodiment, the uplink symbol 106 can be used for uplink transmissions. The inclusion of numerous symbol types can enable devices and network nodes to communicate with each other via transmission and reception of data.

In some examples of the present disclosure, the slot format 102 can include a flexible symbol 110. In at least one example, the flexible symbol 110 disposed in the slot format 102 can be reconfigured as other types of symbols when a UE or base station transmits or receives various signals.

In some embodiments, the slot format 102 can include a pattern of downlink symbols 104, uplink symbols 106, RF symbols 108, and flexible symbols 110. In this manner, various amounts of the different symbols can make up slot format 102. In some examples of the present disclosure, there can be at least one dedicated RF symbol 108 in the pattern of the slot format 102, where the pattern of the slot format 102 can be the order and placement of the symbols in the slot structure of the slot format 102. In at least one example, a dedicated RF symbol 108 in the slot format 102 can enable a UE or a base station transmit the RF symbol 108 to ambient IoT devices.

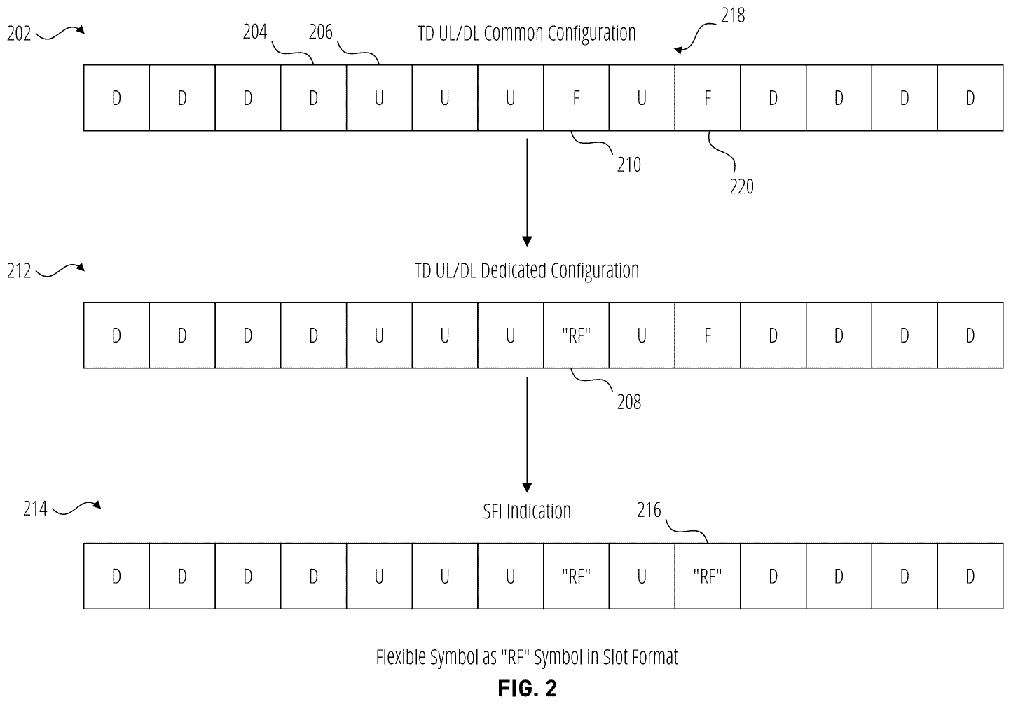

As previously discussed, flexible symbols in a slot format can be reconfigured as different types of symbols included within a slot. FIG. 2 illustrates examples of a flexible symbol 210 reconfigured as an RF symbol within the slot format 202. In conventional slot structures, a flexible symbol can be reconfigured as a downlink symbol 204 or an uplink symbol 206. In some embodiments herein the flexible symbol 210 can also be configured as an RF symbol 208.

In at least one example of the present disclosure, a flexible symbol 210 can be configured by a semi-statically TDD (time division duplex) uplink/downlink (UL/DL) configuration. A flexible symbol 210 in this configuration can then be reconfigured or dynamically indicated as an RF symbol 208. This can enable different patterns of slot formats to add an RF symbol 208.

As shown in FIG. 2, the slot format 202 can configured by a network node using a TDD UL/DL common configuration 218 with an initial set of symbols. The TDD UL/DL common configuration 218 may signal some symbols as flexible symbols. As shown, the slot format 202 can initially be configured with no dedicated RF symbols 208, but rather can include a number of downlink symbols 204, uplink symbols 206, and flexible symbols (e.g., flexible symbol 210, and flexible symbol 220).

In some embodiments, the network node may use the TDD UL/DL dedicated configuration 212 to reconfigure at least some flexible symbols (e.g., flexible symbol 210) as RF symbols (e.g., RF symbol 208). By changing flexible symbols to RF symbols, the slot format 202 can be populated with at least one RF symbol 208. This can be advantageous in that pre-existing slot formats can be used for RF energy harvesting regardless of whether their initial configuration contains RF symbols 208.

For example, as shown in FIG. 2, a TDD UL/DL dedicated configuration 212 can be used by the network node to reconfigure the slot format 202 to have at least one dedicated RF symbol 208. This can enable the ambient IoT devices to receive an RF harvesting signal during the RF symbol 208.

In some embodiments, the TDD UL/DL common and/or dedicated configuration may signal some symbols as flexible symbols and then the dynamic indication (for example slot format indication (SFI) 214 via downlink control information (DCI) can indicate at least some flexible symbols as RF symbols. For example, in the illustrated embodiment, the network node may use a SFI 214 to dynamically indicate a flexible symbol 220 as an RF symbol 216. In some embodiments the SFI 214 or the TDD UL/DL dedicated configuration 212 may be used to alter the flexible symbols. In some embodiments, both the SFI 214 and the TDD UL/DL dedicated configuration 212 may be used to alter the flexible symbols. For example, in at least one example, the SFI 214 can be sent to further repurpose more flexible symbols 220 as RF symbols 216. This can be advantageous in that more flexible symbols 210 can be repurposed as RF symbols 208 in response to dynamic issues.

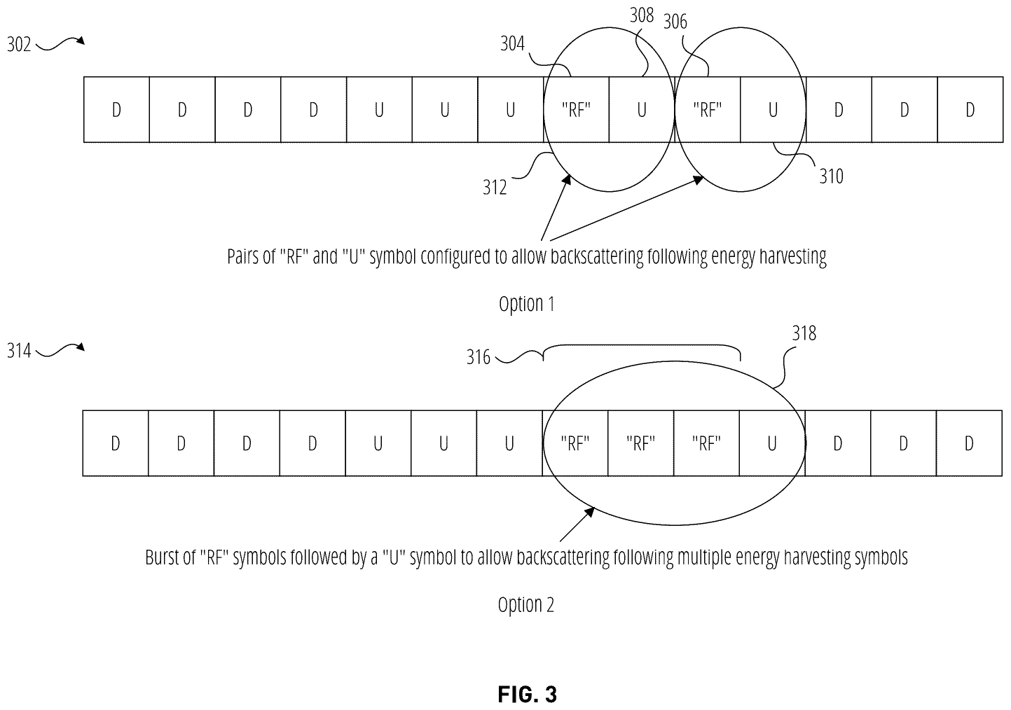

FIG. 3 illustrates various combinations of RF symbols and uplink symbols within a slot in accordance with one or more embodiments of the present disclosure. In general, when an enhanced slot format containing an RF symbol is configured, the RF symbol can be followed by an uplink symbol. This can allow for transmission from different types of ambient IoT devices to be received following energy harvesting. In some embodiments, ambient IoT devices can store harvested energy while others may not. It can be desirable to have different patterns of symbols in slot formats for different kinds of devices. For example, it can be advantageous for the configuration of symbols in a slot transmitted to ambient IoT devices that do not have a means of storing harvested RF energy to be different than the configuration of symbols in a slot transmitted to IoT devices with a means of storing harvested RF energy.

In some embodiments, multiple consecutive RF symbols may not be allowed or supported. The first slot format 302 shown in FIG. 3 illustrates a pattern where multiple consecutive RF symbols are not allowed or supported. For example, every RF symbol may be followed by an UL symbol, then a following symbol can be RF symbol and so on. The pattern can be beneficial for ambient IoT devices without a means of storing harvested RF energy.

For example, some ambient IoT devices do not include a battery, capacitor, or other component(s) for storing energy. In slot formats configured for ambient IoT devices without a means for storing energy, multiple consecutive instances of RF symbols may not be allowed or supported. For example, at least a first RF symbol 304 and a second RF symbol 306 can also be configured in the first slot format 302. Furthermore, at least one uplink symbol 308 can be allocated directly after the first RF symbol 304, and at least one other uplink symbol 310 can be positioned directly after the second RF symbol 306.

In some embodiments, the first slot format 302 can include at least one RF/UL pair 312, where the RF/UL pair 312 can include an RF symbol and an uplink symbol directly after the RF symbol. This configuration can enable ambient IoT devices to utilize harvested energy in direct response to an RF symbol. For example, an ambient IoT device with the first slot format 302 can initially harvest energy in response to the first RF symbol 304 and the ambient IoT device may either send information via backscattering of the signal or a transmission during the uplink symbol 308.

FIG. 3 also illustrates a second slot format 314, where the second slot format 314 can include a symbol pattern different from the symbol pattern found in the first slot format 302. As shown in FIG. 3, the second slot format 314 can be configured to include one or more consecutive RF harvesting symbols. As shown in FIG. 3, these RF symbols can be configured in a consecutive series can define an RF burst 316. Furthermore, the RF burst 316 present in the second slot format 314 can be followed by at least one uplink symbol. In some embodiments of the present disclosure, an RF burst 316 can be followed by a symbol other than an uplink symbol 308.

In some embodiments, the configuration of one or more RF harvesting symbols can be based on the type of an RF powered device. For example, unlike the slot pattern shown in slot format 302 which can be beneficial for ambient IoT devices without the ability to store harvested energy, slot format 314 can include multiple RF symbols that can be configured in series, which can be more beneficial for ambient IoT devices with the ability to store harvested energy.

According to the present disclosure, an RF burst 316, combined with at least one uplink symbol can define a burst sequence 318. Similar to the RF/UL pair 312 discussed previously, the burst sequence 318 can enable an ambient IoT device to harvest RF energy and allow backscattering or transmissions from the ambient IoT device. In some examples, the RF burst 318 can be advantageous to ambient IoT devices that have the ability to store harvested energy. Different sizes of RF bursts 316 can increase the amount of energy harvested by an ambient IoT device. Increasing the amount of harvested energy can amplify backscattering, therefore increasing the power of a signal sent from the ambient IoT device. Additionally, RF bursts 316 allow for an increase the amount of energy stored in an ambient IoT device, which can enable the device to perform more functions between harvesting sessions.

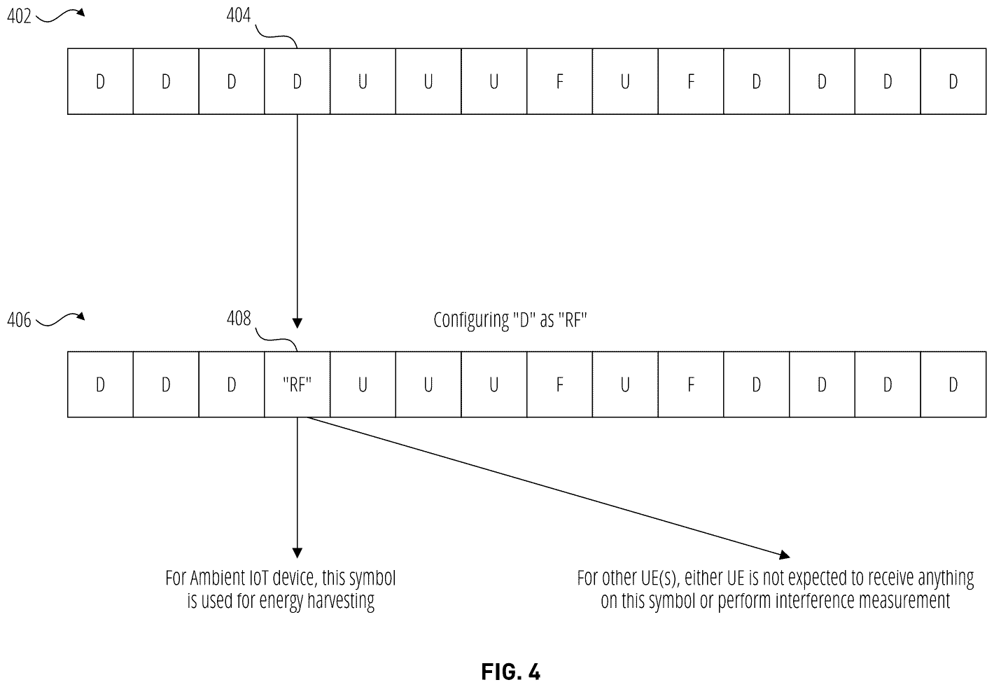

FIG. 4 illustrates an example of configuring downlink symbols as RF signals in accordance with one or more examples of the present disclosure. In at least one example, the network node, or the base station, can act as an emitter of an RF harvesting signal. In the illustrated example, the network node can be configured as the emitter and to send RF harvesting signals to ambient IoT devices and/or other UEs. When in this configuration, the network node can use downlink symbols to transmit data to other devices and/or for RF harvesting signals. As shown, a downlink symbol 404 emitted by the network node can be configured as an RF symbol 408.

As shown in FIG. 4, a network node can include a network node slot format 402, where the network node slot format can be populated with different types of symbols. If the network node is configured as a signal emitter, one or more downlink symbols (e.g., downlink symbol 404) can be used as an RF symbol 408 as shown in reconfigured slot format 406.

For ambient IoT devices, the downlink symbol 404 configured as an RF symbol 408 can be used to for RF energy harvesting. For example, an ambient IoT device may be configured/indicated with DL symbols as RF symbols or DL symbols interpreted as RF symbols for energy harvesting.

In some embodiments, other devices can be configured to receive signals from the network node. Many of these devices may not have the ability to perform RF energy harvesting. Accordingly, the network node may configure/indicate the slot format 402 to other devices (that are not ambient IoT devices) with “DL” symbols as “RF” symbols. For any downlink symbols configured/indicated as an RF symbols, the other devices are not expected to be scheduled with downlink on those symbols.

In some embodiments, the UE(s) can be configured to perform interference measurement when receiving a configured RF symbol 408. Interference measurements can be advantageous in that the UE(s) can be configured to measure the interference during a configured RF symbol 408. The UE(s) can then report back measurements to the network. These measurements can then be used to determine the interference caused by RF harvesting signals, which can help determine optimal co-existence for signals between the network node and ambient IoT and signals between the network node and UE(s).

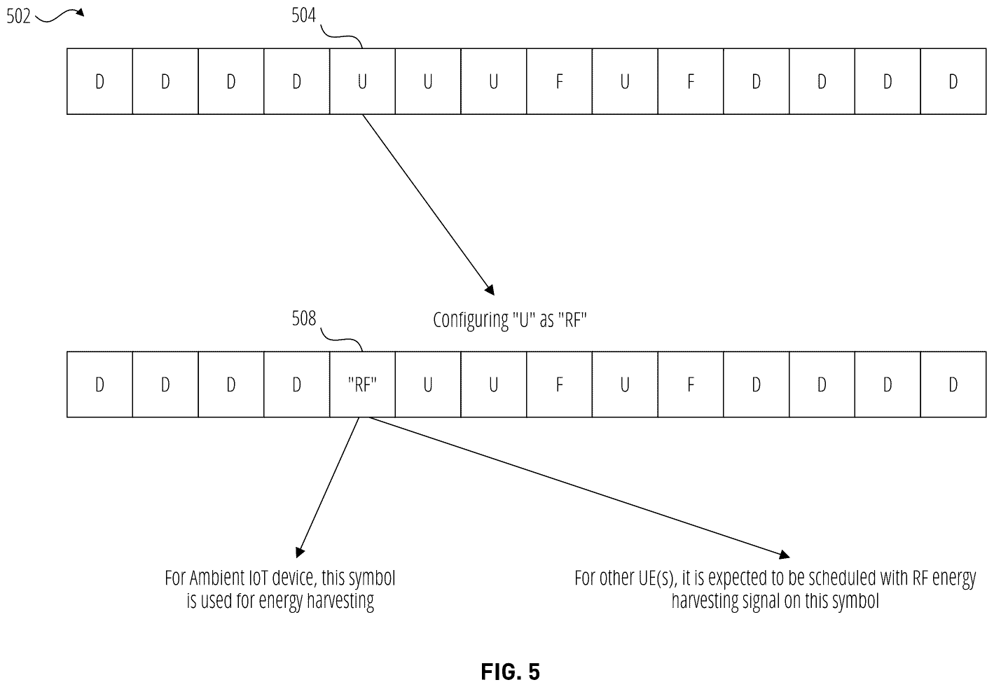

FIG. 5 illustrates an example of configuring uplink symbols as RF signals in accordance with one or more examples of the present disclosure. In at least one example, the UE can act as an emitter of an RF harvesting signal. When in this configuration, the UE can use one or more uplink symbols (e.g., uplink symbol 504) to either transmit data to other devices, or as one or more RF symbols (e.g., RF symbol 508). Ambient IoT device can be configured/indicated with UL symbols as RF symbols or UL symbols interpreted as RF symbols for energy harvesting. Other UEs (that are not ambient IoT) device configured/indicated with UL symbols as RF symbols are expected to be scheduled with RF signal on those symbols.

As shown in FIG. 5, a slot format 502 can be configured with different types of symbols (e.g., UL, DL, Flexible). If the UE is configured as a signal emitter, an uplink symbol 504 can be used by the UE to transmit an RF harvesting symbol to ambient IoT devices. In this example, one of the uplink symbols 504 is reconfigured as an RF symbol 508. The uplink symbol 504 configured as an RF symbol 508 can be used to by the UE and ambient IoT device for RF energy harvesting.

In some embodiments of the present disclosure, an ambient device configured with an RF symbol can receive an energy harvesting signal from an emitter (device emitting a signal) and respond back with a backscatter signal during the same RF symbol to the reader (device reading a signal). In other words, a transmission of an RF harvesting signal and the reception of a backscattering signal from an ambient IoT device can occur during the same RF symbol. In this example, the emitter can be a network node, a UE, or another device capable of transmitting signals to an ambient IoT device. This can be advantageous in that an ambient IoT device can immediately provide feedback in response to an RF harvesting signal.

In some embodiments, an ambient IoT device can respond back to an emitter on the same RF symbol in mono-static mode or in bi-static mode. In at least one embodiment, mono-static mode can be defined as when the reader and the emitter are the same device. Conversely, bi-static mode can be defined as when the reader and the emitter are different devices.

In some embodiments, a UE (other than an ambient IoT device) may be configured with an RF symbol and configured as an emitter. The UE can expect to be scheduled with the transmission of an RF energy harvesting signal to ambient IoT devices during the RF symbol.

In some embodiments, a UE (other than an ambient IoT device) can be configured with an RF symbol and configured as a reader. The UE can expect to be scheduled with the reception of a backscattering signal from an ambient IoT device during the RF symbol.

In another embodiment, another UE (other than an ambient IoT device) configured with an RF symbol and configured as both emitter and reader can expect to be scheduled with transmission of an RF energy harvesting signal to an ambient IoT device, and tasked with reception of a backscattering signal from an ambient IoT device on the same RF symbol.

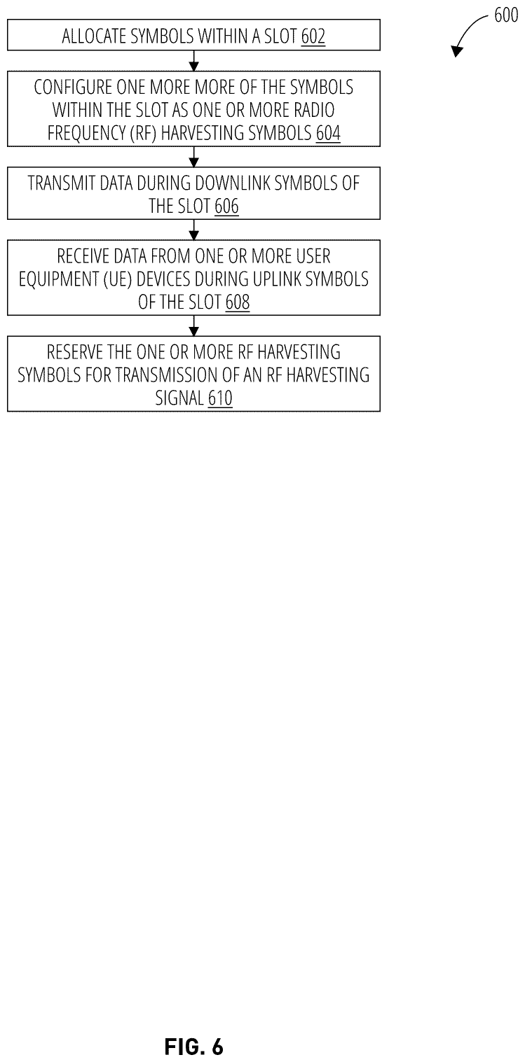

FIG. 6 illustrates a method 600 for a network node according to embodiments herein. The illustrated method 600 includes allocating 602 symbols within a slot. Furthermore, the method 600 includes configuring 604 one or more of the symbols within the slot as one or more Radio Frequency (RF) harvesting symbols. As shown in FIG. 6, the method 600 also includes transmitting 606 data during downlink symbols of the slot. The method further includes receiving 608 data from one or more user equipment (UE) devices during uplink symbols of the slot. Additionally, the method 600 includes reserving 610 the one or more RF harvesting symbols for transmission of an RF harvesting signal.

In some embodiments of the method 600, a slot can include a slot format that further includes a symbol type specifically for the RF harvesting symbols.

In some embodiments of the method 600, configuring one or more RF harvesting symbols can include reconfiguring a flexible symbol. In some such embodiments, a dynamic indication can also be sent to indicate that the flexible symbol is one of the RF harvesting symbols.

In some embodiments of the method 600, configuring the one or more RF harvesting symbols can include configuring a first RF harvesting symbol and a second RF harvesting symbol. Additionally, some embodiments of the method 600 can further include allocating at least one of the uplink symbols after the first RF harvesting symbol, and at least one other of the uplink symbols after the second RF harvesting symbol.

In some embodiments of the method 600, configuring one or more RF harvesting symbols can include configuring multiple RF harvesting symbols consecutively in a burst, where the burst is followed by at least one of the uplink symbols.

In some embodiments of the method 600, the network node can act as an emitter of the RF harvesting signal. In some such embodiments, one or more of the downlink symbols are configured as the one or more RF harvesting symbols.

In some embodiments of the method 600, a first UE device from the one or more UE devices can act as an emitter of the RF harvesting signal. Additionally, one or more of the uplink symbols can be configured as the one or more RF harvesting symbols.

In some embodiments of the method 600, reception of the RF harvesting signal and transmission of a corresponding backscattering from a UE device can occur on a same RF harvesting symbol.

In some embodiments of the method 600, reception of the corresponding backscattering is on a same symbol and a same frequency as the RF harvesting signal (i.e. full-duplex TDD).

In some embodiments of the method 600, reception of backscattering is on a same symbol, but a different (shifted) frequency than the RF harvesting signal (i.e. FDD).

In some embodiments of the method 600, the RF harvesting symbol is used for unmodulated signal transmission or modulated signal transmission.

In some embodiments of the method 600, the method 600 can further include receiving an interference measurement associated with the RF harvesting symbols.

In some embodiments of the method 600, configuring one or more RF harvesting symbols can be based on a type of an RF powered device.

In some embodiments on the symbols configured as RF symbols, only unmodulated signal transmission (i.e. carrier wave) is allowed.

In some embodiments on the symbols configured as RF symbol, modulated signal transmission (for example a physical channel or reference signal) is allowed.

In some embodiments, the UEs (that are not ambient IoT) device configured/indicated with UL symbols as RF symbols are expected to measure interference measurement on RF symbols and report back measurements to the network. This can be beneficial to determine the interference caused by RF signals to UEs (other than ambient IoT) for optimal co-existence.

In some embodiments, for ambient device type A, only a pair of RF and UL symbol can be configured (i.e. RF symbol followed by UL symbol). In some embodiments, for ambient device type B or type C, it is allowed to have one or multiple consecutive RF symbols and without any following UL symbol.

Embodiments contemplated herein include an apparatus comprising means to perform one or more elements of the method 600. This apparatus may be, for example, an apparatus of a base station (such as a network device 918 that is a base station, as described herein).

Embodiments contemplated herein include one or more non-transitory computer-readable media comprising instructions to cause an electronic device, upon execution of the instructions by one or more processors of the electronic device, to perform one or more elements of the method 600. This non-transitory computer-readable media may be, for example, a memory of a base station (such as a memory 922 of a network device 918 that is a base station, as described herein).

Embodiments contemplated herein include an apparatus comprising logic, modules, or circuitry to perform one or more elements of the method 600. This apparatus may be, for example, an apparatus of a base station (such as a network device 918 that is a base station, as described herein).

Embodiments contemplated herein include an apparatus comprising: one or more processors and one or more computer-readable media comprising instructions that, when executed by the one or more processors, cause the one or more processors to perform one or more elements of the method 600. This apparatus may be, for example, an apparatus of a base station (such as a network device 918 that is a base station, as described herein).

Embodiments contemplated herein include a signal as described in or related to one or more elements of the method 600.

Embodiments contemplated herein include a computer program or computer program product comprising instructions, wherein execution of the program by a processing element is to cause the processing element to carry out one or more elements of the method 600. The processor may be a processor of a base station (such as a processor(s) 920 of a network device 918 that is a base station, as described herein). These instructions may be, for example, located in the processor and/or on a memory of the base station (such as a memory 922 of a network device 918 that is a base station, as described herein).

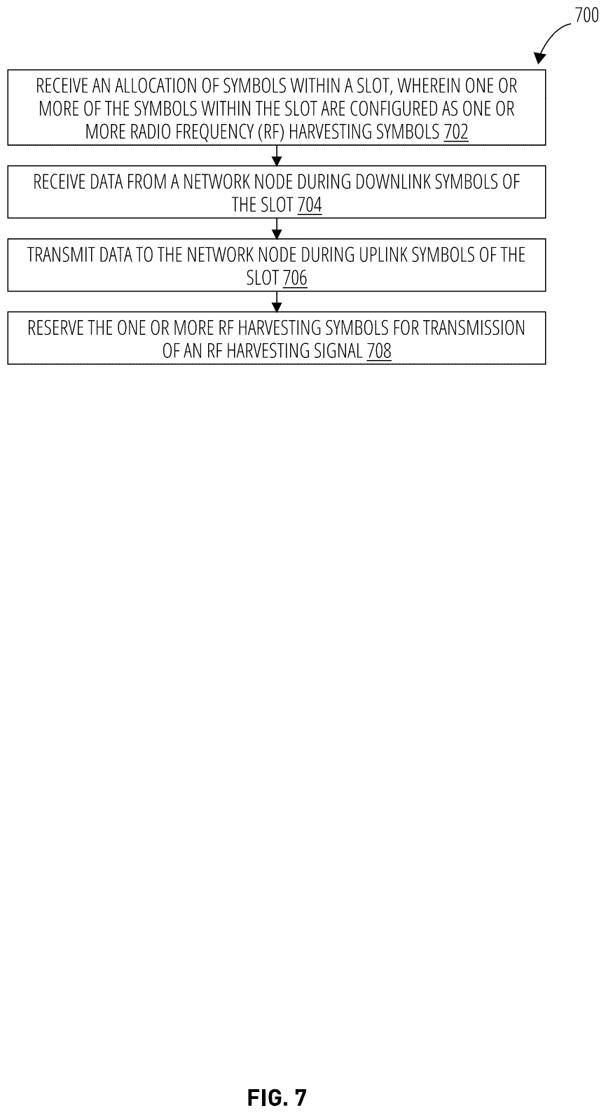

FIG. 7 illustrates a method 700 for a UE according to embodiments herein. The illustrated method 700 includes receiving 702 an allocation of symbols within a slot, wherein one or more of the symbols within the slot are configured as one or more Radio Frequency (RF) harvesting symbols. The method 700 further includes receiving 704 data from a network node during downlink symbols of the slot. Additionally, the method 700 can include transmitting 706 data to the network node during uplink symbols of the slot. The method 700 can further include reserving 708 the one or more RF harvesting symbols for transmission of an RF harvesting signal.

In some embodiments of the method 700, the slot can include a slot format that includes a symbol type specifically for the RF harvesting symbols.

In some embodiments of the method 700, the method 700 can further include receiving a reconfiguration for a flexible symbol to reconfigure the flexible symbol as one of the RF harvesting symbols.

In some embodiments of the method 700, the method 700 can further include receiving a dynamic indication indicating a flexible symbol as one of the RF harvesting symbols.

In some embodiments of the method 700, the slot can include a first RF harvesting symbol and a second RF harvesting symbol. In some such embodiments, the slot can include at least one of the uplink symbols after the first RF harvesting symbol, and at least one other of the uplink symbols after the second RF harvesting symbol.

In some embodiments of the method 700, the slot can include multiple RF harvesting symbols consecutively in a burst. Additionally, the burst can be followed by at least one of the uplink symbols.

In some embodiments of the method 700, the network node can act as an emitter of the RF harvesting signal. In some such embodiments, one or more of the downlink symbols can be configured as the one or more RF harvesting symbols.

In some embodiments of the method 700, a UE can act as an emitter of the RF harvesting signal. Additionally, one or more of the uplink symbols can be configured as the one or more RF harvesting symbols.

In some embodiments of the method 700, reception of the RF harvesting signal and transmission of a corresponding backscattering from a UE device can occur on a same RF harvesting symbol.

In some embodiments of the method 700, reception of the corresponding backscattering is on a same symbol and a same frequency as the RF harvesting signal (i.e. full-duplex TDD).

In some embodiments of the method 700, reception of backscattering is on a same symbol, but a different (shifted) frequency than the RF harvesting signal (i.e. FDD).

In some embodiments of the method 700, the RF harvesting symbol can be used for unmodulated signal transmission or modulated signal transmission.

In some embodiments of the method 700, the method 700 can further include performing an interference measurement during one or more of the RF harvesting symbols.

In some embodiments of the method 700, configuration of the one or more RF harvesting symbols can be based on a type of an RF powered device.

Embodiments contemplated herein include an apparatus comprising means to perform one or more elements of the method 700. This apparatus may be, for example, an apparatus of a UE (such as a wireless device 902 that is a UE, as described herein).

Embodiments contemplated herein include one or more non-transitory computer-readable media comprising instructions to cause an electronic device, upon execution of the instructions by one or more processors of the electronic device, to perform one or more elements of the method 700. This non-transitory computer-readable media may be, for example, a memory of a UE (such as a memory 906 of a wireless device 902 that is a UE, as described herein).

Embodiments contemplated herein include an apparatus comprising logic, modules, or circuitry to perform one or more elements of the method 700. This apparatus may be, for example, an apparatus of a UE (such as a wireless device 902 that is a UE, as described herein).

Embodiments contemplated herein include an apparatus comprising: one or more processors and one or more computer-readable media comprising instructions that, when executed by the one or more processors, cause the one or more processors to perform one or more elements of the method 700. This apparatus may be, for example, an apparatus of a UE (such as a wireless device 902 that is a UE, as described herein).

Embodiments contemplated herein include a signal as described in or related to one or more elements of the method 700.

Embodiments contemplated herein include a computer program or computer program product comprising instructions, wherein execution of the program by a processor is to cause the processor to carry out one or more elements of the method 700. The processor may be a processor of a UE (such as a processor(s) 904 of a wireless device 902 that is a UE, as described herein). These instructions may be, for example, located in the processor and/or on a memory of the UE (such as a memory 906 of a wireless device 902 that is a UE, as described herein).

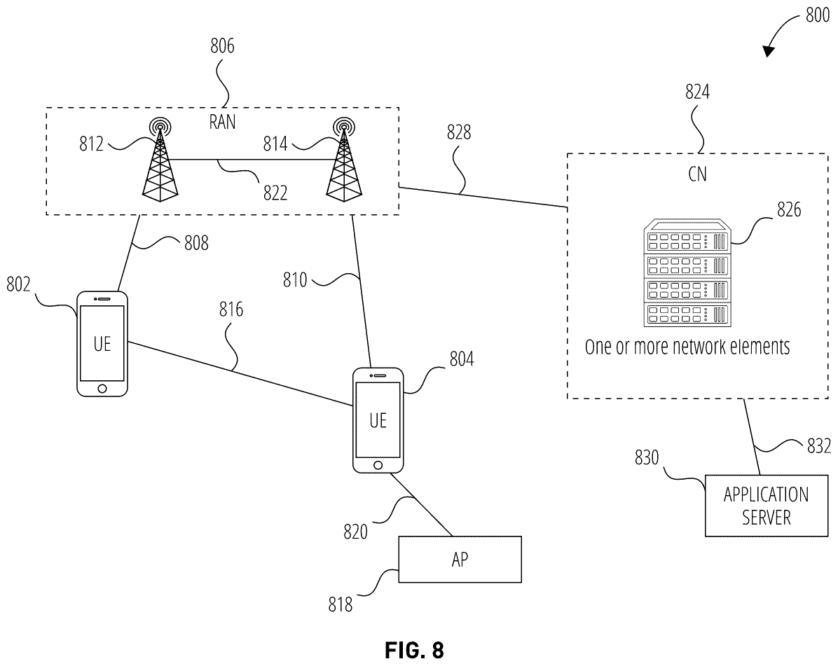

FIG. 8 illustrates an example architecture of a wireless communication system 800, according to embodiments disclosed herein. The following description is provided for an example wireless communication system 800 that operates in conjunction with the LTE system standards and/or 5G or NR system standards as provided by 3GPP technical specifications.

As shown by FIG. 8, the wireless communication system 800 includes UE 802 and UE 804 (although any number of UEs may be used). In this example, the UE 802 and the UE 804 are illustrated as smartphones (e.g., handheld touchscreen mobile computing devices connectable to one or more cellular networks), but may also comprise any mobile or non-mobile computing device configured for wireless communication.

The UE 802 and UE 804 may be configured to communicatively couple with a RAN 806. In embodiments, the RAN 806 may be NG-RAN, E-UTRAN, etc. The UE 802 and UE 804 utilize connections (or channels) (shown as connection 808 and connection 810, respectively) with the RAN 806, each of which comprises a physical communications interface. The RAN 806 can include one or more base stations (such as base station 812 and base station 814) that enable the connection 808 and connection 810.

In this example, the connection 808 and connection 810 are air interfaces to enable such communicative coupling, and may be consistent with RAT(s) used by the RAN 806, such as, for example, an LTE and/or NR.

In some embodiments, the UE 802 and UE 804 may also directly exchange communication data via a sidelink interface 816. The UE 804 is shown to be configured to access an access point (shown as AP 818) via connection 820. By way of example, the connection 820 can comprise a local wireless connection, such as a connection consistent with any IEEE 802.11 protocol, wherein the AP 818 may comprise a Wi-Fi® router. In this example, the AP 818 may be connected to another network (for example, the Internet) without going through a CN 824.

In embodiments, the UE 802 and UE 804 can be configured to communicate using orthogonal frequency division multiplexing (OFDM) communication signals with each other or with the base station 812 and/or the base station 814 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 812 or base station 814 may be implemented as one or more software entities running on server computers as part of a virtual network. In addition, or in other embodiments, the base station 812 or base station 814 may be configured to communicate with one another via interface 822. In embodiments where the wireless communication system 800 is an LTE system (e.g., when the CN 824 is an EPC), the interface 822 may be an X2 interface. The X2 interface may be defined between two or more base stations (e.g., two or more eNBs and the like) that connect to an EPC, and/or between two eNBs connecting to the EPC. In embodiments where the wireless communication system 800 is an NR system (e.g., when CN 824 is a 5GC), the interface 822 may be an Xn interface. The Xn interface is defined between two or more base stations (e.g., two or more gNBs and the like) that connect to 5GC, between a base station 812 (e.g., a gNB) connecting to 5GC and an eNB, and/or between two eNBs connecting to 5GC (e.g., CN 824).

The RAN 806 is shown to be communicatively coupled to the CN 824. The CN 824 may comprise one or more network elements 826, which are configured to offer various data and telecommunications services to customers/subscribers (e.g., users of UE 802 and UE 804) who are connected to the CN 824 via the RAN 806. The components of the CN 824 may be implemented in one physical device or separate physical devices including components to read and execute instructions from a machine-readable or computer-readable medium (e.g., a non-transitory machine-readable storage medium).

In embodiments, the CN 824 may be an EPC, and the RAN 806 may be connected with the CN 824 via an S1 interface 828. In embodiments, the S1 interface 828 may be split into two parts, an S1 user plane (S1-U) interface, which carries traffic data between the base station 812 or base station 814 and a serving gateway (S-GW), and the S1-MME interface, which is a signaling interface between the base station 812 or base station 814 and mobility management entities (MMEs).

In embodiments, the CN 824 may be a 5GC, and the RAN 806 may be connected with the CN 824 via an NG interface 828. In embodiments, the NG interface 828 may be split into two parts, an NG user plane (NG-U) interface, which carries traffic data between the base station 812 or base station 814 and a user plane function (UPF), and the S1 control plane (NG-C) interface, which is a signaling interface between the base station 812 or base station 814 and access and mobility management functions (AMFs).

Generally, an application server 830 may be an element offering applications that use internet protocol (IP) bearer resources with the CN 824 (e.g., packet switched data services). The application server 830 can also be configured to support one or more communication services (e.g., VOIP sessions, group communication sessions, etc.) for the UE 802 and UE 804 via the CN 824. The application server 830 may communicate with the CN 824 through an IP communications interface 832.

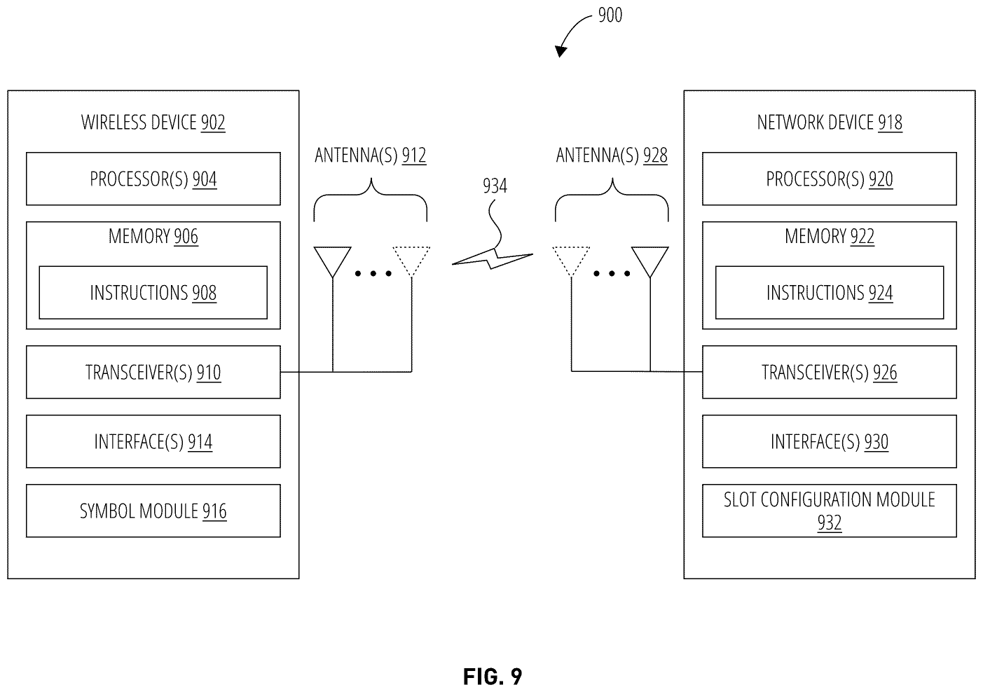

FIG. 9 illustrates a system 900 for performing signaling 934 between a wireless device 902 and a network device 918, according to embodiments disclosed herein. The system 900 may be a portion of a wireless communications system as herein described. The wireless device 902 may be, for example, a UE of a wireless communication system. The network device 918 may be, for example, a base station (e.g., an eNB or a gNB) of a wireless communication system.

The wireless device 902 may include one or more processor(s) 904. The processor(s) 904 may execute instructions such that various operations of the wireless device 902 are performed, as described herein. The processor(s) 904 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 902 may include a memory 906. The memory 906 may be a non-transitory computer-readable storage medium that stores instructions 908 (which may include, for example, the instructions being executed by the processor(s) 904). The instructions 908 may also be referred to as program code or a computer program. The memory 906 may also store data used by, and results computed by, the processor(s) 904.

The wireless device 902 may include one or more transceiver(s) 910 that may include radio frequency (RF) transmitter circuitry and/or receiver circuitry that use the antenna(s) 912 of the wireless device 902 to facilitate signaling (e.g., the signaling 934) to and/or from the wireless device 902 with other devices (e.g., the network device 918) according to corresponding RATs.

The wireless device 902 may include one or more antenna(s) 912 (e.g., one, two, four, or more). For embodiments with multiple antenna(s) 912, the wireless device 902 may leverage the spatial diversity of such multiple antenna(s) 912 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 902 may be accomplished according to precoding (or digital beamforming) that is applied at the wireless device 902 that multiplexes the data streams across the antenna(s) 912 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 902 may implement analog beamforming techniques, whereby phases of the signals sent by the antenna(s) 912 are relatively adjusted such that the (joint) transmission of the antenna(s) 912 can be directed (this is sometimes referred to as beam steering).

The wireless device 902 may include one or more interface(s) 914. The interface(s) 914 may be used to provide input to or output from the wireless device 902. For example, a wireless device 902 that is a UE may include interface(s) 914 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 910/antenna(s) 912 already described) that allow for communication between the UE and other devices and may operate according to known protocols (e.g., Wi-Fi®, Bluetooth® and the like).

The wireless device 902 may include a symbol module 916. The symbol module 916 may be implemented via hardware, software, or combinations thereof. For example, the symbol module 916 may be implemented as a processor, circuit, and/or instructions 908 stored in the memory 906 and executed by the processor(s) 904. In some examples, the symbol module 916 may be integrated within the processor(s) 904 and/or the transceiver(s) 910. For example, the symbol module 916 may be implemented by a combination of software components (e.g., executed by a DSP or a general processor) and hardware components (e.g., logic gates and circuitry) within the processor(s) 904 or the transceiver(s) 910.

The symbol module 916 may be used for various aspects of the present disclosure, for example, aspects of FIGS. 1-8. The symbol module 916 is configured to determine the symbol types of a slot.

The network device 918 may include one or more processor(s) 920. The processor(s) 920 may execute instructions such that various operations of the network device 918 are performed, as described herein. The processor(s) 920 may include one or more baseband processors implemented using, for example, a CPU, a DSP, an ASIC, a controller, an FPGA device, another hardware device, a firmware device, or any combination thereof configured to perform the operations described herein.

The network device 918 may include a memory 922. The memory 922 may be a non-transitory computer-readable storage medium that stores instructions 924 (which may include, for example, the instructions being executed by the processor(s) 920). The instructions 924 may also be referred to as program code or a computer program. The memory 922 may also store data used by, and results computed by, the processor(s) 920.

The network device 918 may include one or more transceiver(s) 926 that may include RF transmitter circuitry and/or receiver circuitry that use the antenna(s) 928 of the network device 918 to facilitate signaling (e.g., the signaling 934) to and/or from the network device 918 with other devices (e.g., the wireless device 902) according to corresponding RATs.

The network device 918 may include one or more antenna(s) 928 (e.g., one, two, four, or more). In embodiments having multiple antenna(s) 928, the network device 918 may perform MIMO, digital beamforming, analog beamforming, beam steering, etc., as has been described.

The network device 918 may include one or more interface(s) 930. The interface(s) 930 may be used to provide input to or output from the network device 918. For example, a network device 918 that is a base station may include interface(s) 930 made up of transmitters, receivers, and other circuitry (e.g., other than the transceiver(s) 926/antenna(s) 928 already described) that enables the base station to communicate with other equipment in a core network, and/or that enables the base station to communicate with external networks, computers, databases, and the like for purposes of operations, administration, and maintenance of the base station or other equipment operably connected thereto.

The network device 918 may include a slot configuration module 932. The slot configuration module 932 may be implemented via hardware, software, or combinations thereof. For example, the slot configuration module 932 may be implemented as a processor, circuit, and/or instructions 924 stored in the memory 922 and executed by the processor(s) 920. In some examples, the slot configuration module 932 may be integrated within the processor(s) 920 and/or the transceiver(s) 926. For example, the slot configuration module 932 may be implemented by a combination of software components (e.g., executed by a DSP or a general processor) and hardware components (e.g., logic gates and circuitry) within the processor(s) 920 or the transceiver(s) 926.

The slot configuration module 932 may be used for various aspects of the present disclosure, for example, aspects of FIGS. 1-8. The slot configuration module 932 is configured to configure the symbols of a slot.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method for a network node, the method comprising:
allocating symbols within a slot;
configuring one or more of the symbols within the slot as one or more Radio Frequency (RF) harvesting symbols;
transmitting data during downlink symbols of the slot;
receiving data from one or more user equipment (UE) devices during uplink symbols of the slot; and
reserving the one or more RF harvesting symbols for transmission of an RF harvesting signal.

2. The method of claim 1, wherein the slot comprises a slot format that includes a symbol type specifically for the RF harvesting symbols.

3. The method of claim 1, wherein configuring the one or more RF harvesting symbols comprises reconfiguring a flexible symbol, or sending a dynamic indication to indicate that the flexible symbol is one of the RF harvesting symbols.

4. The method of claim 1, wherein configuring the one or more RF harvesting symbols comprises:
configuring a first RF harvesting symbol and a second RF harvesting symbol; and
allocating at least one of the uplink symbols after the first RF harvesting symbol, and at least one other of the uplink symbols after the second RF harvesting symbol.

5. The method of claim 1, wherein configuring the one or more RF harvesting symbols comprises configuring multiple RF harvesting symbols consecutively in a burst, wherein the burst is followed by at least one of the uplink symbols.

6. The method of claim 1, wherein the network node acts as an emitter of the RF harvesting signal, and wherein one or more of the downlink symbols are configured as the one or more RF harvesting symbols.

7. The method of claim 1, wherein a first UE device from the one or more UE devices acts as an emitter of the RF harvesting signal, and wherein one or more of the uplink symbols are configured as the one or more RF harvesting symbols.

8. The method of claim 1, wherein reception of the RF harvesting signal, and transmission of a corresponding backscattering from a UE device occurs on a same RF harvesting symbol.

9. The method of claim 8, wherein reception of the corresponding backscattering is on a same symbol and a same frequency as the RF harvesting signal.

10. The method of claim 8, wherein reception of the corresponding backscattering is on a same symbol, but a different frequency than the RF harvesting signal.

11. The method of claim 1, wherein the RF harvesting symbol is used for unmodulated signal transmission or modulated signal transmission.

12. The method of claim 1, further comprising receiving an interference measurement associated with the RF harvesting symbols.

13. The method of claim 1, wherein configuring the one or more RF harvesting symbols is based on a type of an RF powered device.

14. A method for a user equipment (UE), the method comprising:
receiving an allocation of symbols within a slot, wherein one or more of the symbols within the slot are configured as one or more Radio Frequency (RF) harvesting symbols;
receiving data from a network node during downlink symbols of the slot;
transmitting data to the network node during uplink symbols of the slot; and
reserving the one or more RF harvesting symbols for transmission of an RF harvesting signal.

15. The method of claim 14, wherein the slot comprises a slot format that includes a symbol type specifically for the RF harvesting symbols.

16. The method of claim 14, further comprising receiving a reconfiguration for a flexible symbol to reconfigure the flexible symbol as one of the RF harvesting symbols.

17. The method of claim 14, further comprising receiving a dynamic indication indicating a flexible symbol as one of the RF harvesting symbols.

18. The method of claim 14, wherein the slot comprises a first RF harvesting symbol and a second RF harvesting symbol,
wherein the slot includes at least one of the uplink symbols after the first RF harvesting symbol, and at least one other of the uplink symbols after the second RF harvesting symbol.

19. The method of claim 14, wherein the slot comprises multiple RF harvesting symbols consecutively in a burst, wherein the burst is followed by at least one of the uplink symbols.

20. The method of claim 14, wherein the network node acts as an emitter of the RF harvesting signal, and wherein one or more of the downlink symbols are configured as the one or more RF harvesting symbols.
